(19) United States
(12) Patent Application Publication
(10) Pub. No.: US 2010/0149684 A1
(43) Pub. Date: Jun. 17, 2010

(54) DATA-STORAGE DEVICE AND ANALYSIS METHOD FOR DATA-STORAGE DEVICE

(76) Inventors: Akira KOJIMA, Kanagawa (JP); Yoshiju Watanabe, Kanagawa (JP); Takeshi Shikama, Kanagawa (JP); Masatoshi Nishina, Kanagawa (JP)

Correspondence Address: HITACHI C/O WAGNER BLECHER LLP, 123 WESTRIDGE DRIVE, WATSONVILLE, CA, 95076, US

(21) Appl. No.: 12/639,014

(22) Filed: Dec. 16, 2009

(30) Foreign Application Priority Data
Dec. 16, 2008 (JP) 2008-320329

(51) Int. Cl. G11B 5/596; H04L 1/00

(52) U.S. Cl. 360/77.04; 714/746; G9B/5.216

(57) ABSTRACT

A data-storage device with a security function for user data stored in a data-storage medium. The data-storage device includes: the data-storage medium for storing data; an authentication processing section for performing an authentication process with a key obtained from a host; an error correction circuit for performing error correction in reading data at an address designated by a read command from a host which has been recognized as an authorized user for analysis access by the authentication processing section; and an analysis processing section for generating data indicating the positions of the error correction and transferring the data to the host.

### CROSS-REFERENCE TO RELATED APPLICATION

This application claims priority from the Japanese Patent Application No. 2008-320329, filed Dec. 16, 2008 the disclosure of which is incorporated herein in its entirety by reference.

### TECHNICAL FIELD

Embodiments of the present invention relate to a data-storage device and an analysis method of a data-storage device.

### BACKGROUND

Various media for storing data are known in the art, such as: optical disks, magneto-optical disks, magnetic-recording disks and semiconductor memories. Security measures for data stored on such media are also known in the art, in particular, data-storage devices to store data by use of these media with a security function to protect user data stored in a data-storage medium from unauthorized access.

For example, hard-disk drives (HDDs) with security functions to respond to user needs to ensure the confidentiality of user data are known in the art. HDDs are known in the art that encrypt data before storing the data. A host computer holds a security key and is capable of reading data from a magnetic-recording disk and writing data to the magnetic-recording disk by use of the security key. A host computer without the security key is capable of neither reading data, nor writing data.

Engineers and scientists engaged in HDD manufacturing and development are interested in the design of HDDs that utilize such security features to meet the rising demands of the marketplace for increased functionality in the HDD, as well as reliability.

### SUMMARY

Embodiments of the present invention include a data-storage device with a security function for user data stored in a data-storage medium. The data-storage device includes: the data-storage medium for storing data; an authentication processing section for performing an authentication process with a key obtained from a host; an error correction circuit for performing error correction in reading data at an address designated by a read command from a host which has been recognized as an authorized user for analysis access by the authentication processing section; and an analysis processing section for generating data indicating the positions of the error correction and transferring the data to the host.

### DESCRIPTION OF THE DRAWINGS

The accompanying drawings, which are incorporated in and form a part of this specification, illustrate embodiments of the invention and, together with the description, serve to explain the embodiments of the present invention:

FIG. 1 is an example block diagram schematically depicting the configuration of a hard-disk drive (HDD), in accordance with an embodiment of the present invention.

FIG. 2 is an example block diagram schematically illustrating configuration elements associated with a cryptographic process, in accordance with an embodiment of the present invention.

FIG. 3 is an example drawing illustrating an authentication process and an encryption process of user data in reading and writing operations of user data, in accordance with an embodiment of the present invention.

FIG. 4 is an example block diagram schematically illustrating a process in which a vendor reads data from a HDD in a failure analysis of the HDD, in accordance with an embodiment of the present invention.

FIG. 5 is an example block diagram illustrating a data write method in the failure analysis, in accordance with an embodiment of the present invention.

FIG. 6 is an example block diagram illustrating an operation to a read long command in a failure analysis, in accordance with an embodiment of the present invention.

FIG. 7 is an example block diagram illustrating an operation to a write long command in a failure analysis, in accordance with an embodiment of the present invention.

FIG. 8 is an example block diagram illustrating an operation to a read long command in a failure analysis, in accordance with an embodiment of the present invention.

FIG. 9 is an example block diagram illustrating an operation to a write long command in a failure analysis, in accordance with an embodiment of the present invention.

The drawings referred to in this description should not be understood as being drawn to scale except if specifically noted.

### DESCRIPTION OF EMBODIMENTS

Reference will now be made in detail to the alternative embodiments of the present invention. While the invention will be described in conjunction with the alternative embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following description of embodiments of the present invention, numerous specific details are set forth in order to provide a thorough understanding of the present invention. However, it should be noted that embodiments of the present invention may be practiced without these specific details. In other instances, well known methods, procedures, and components have not been described in detail as not to unnecessarily obscure embodiments of the present invention. Throughout the drawings, like components are denoted by like reference numerals, and repetitive descriptions are omitted for clarity of explanation if not necessary.

### Description of Embodiments of the Present Invention for a Data-Storage Device and an Analysis Method for the Data-Storage Device

With relevance to embodiments of the present invention, failure analyses (FA) of failed hard-disk drives (HDDs) are utilized for various user purposes. A failed HDD is returned to the vendor from a user; and, the vendor analyzes the HDD to find a failure common to other HDDs. However, if a HDD has a security function, a host computer of the HDD vendor can neither read data from the HDD, nor write data to the HDD. Thus, the HDD vendor can not analyze errors in the read/write system in the HDD.

If the HDD vendor has the security key, the HDD vendor can read data from, or write data to, a HDD with a security function. However, the HDD vendor can access, as well, magnetic-recording disks without restriction; and, confidential user data, which the user intends to protect, may be revealed to the HDD vendor.

A technique, known in the art, which provides for nondisclosure of user data to HDD vendors, is next described that both maintains the security of user data and, at the same time, allows for failure analysis of the HDD. A HDD encrypts user data and stores the encrypted user data to a magnetic-recording disk. Furthermore, the HDD has two keys, a user password and a manufacturer password, for a security lock. If the lock is released with the user password, the HDD outputs plaintext user data. If the lock is released with the manufacturer password, the HDD outputs encrypted user data, which allows a vendor to inspect and repair HDDs without the contents of user data being revealed.

Sometimes, however, location of error positions in error correction during failure analysis of a HDD is also performed. If a HDD returns encrypted user data in response to access with the manufacture password as in the above-described technique, location of error positions in a data sector may be barred. Thus, a technique is desired that allows a HDD vendor to locate error correction positions in a failed HDD and perform a precise failure analysis while maintaining user data security, which provides for nondisclosure to HDD vendors.

Embodiments of the present invention include a data-storage device with a security function for user data stored in a data-storage medium. In accordance with embodiments of the present invention, the data-storage device includes: a data-storage medium for storing data; an authentication processing section for performing an authentication process with a key obtained from a host; an error correction circuit for performing error correction in reading data at an address designated by a read command from a host which has been recognized as an authorized user for analysis access by the authentication processing section; and, an analysis processing section for generating data indicating the positions of the error correction and transferring the data to the host. Thus, embodiments of the present invention provide for failure analysis of a data-storage device with a security function without the contents of user data being revealed.

In one embodiment of the present invention, the generated data has the same data length as the data designated by the read command and that the generated data is data in which bits at the error corrected positions are different from the other bits in a specified fixed data pattern.

Embodiments of the present invention provide for reporting error correction positions with the same specifications as an ordinary read command. In accordance with an embodiment of the present invention, if error correction of the data designated by the read command is barred, the analysis processing section transfers data whose data length is the same as the designated data and having a specified bit pattern to the host. Thus, embodiments of the present invention provide for reporting the impossibility of error correction with the same specifications as an ordinary read command.

In accordance with an embodiment of the present invention, the analysis processing section is configured to receive a write command designating an address in the data-storage medium and bit inversion positions, and is configured to write data obtained by inverting bits at the designated positions in the data read from the address to the address. Thus, embodiments of the present invention provide for data write and subsequent data recovery. In one embodiment of the present invention, the read command is a read long command for instructing transfer of data at a designated address and an ECC code. Thus, in an embodiment of the present invention, a read long command may be used in the analysis for instructing transfer of data at a designated address and an ECC code.

In another embodiment of the present invention, the analysis processing section is configured to receive a write long command designating the same address as the read long command and designating bit inversion positions in the data at the designated address and an ECC code, and is configured to write data obtained by inverting bits at the designated positions in the data read from the designated address and the ECC code to the address. Thus, embodiments of the present invention provide for an analysis with a read long command and data recovery.

Embodiments of the present invention also include an analysis method of a data-storage device with a security function for user data. In accordance with embodiments of the present invention, the method performs an authentication process of access from an authorized host for analysis with a key obtained from the host. In accordance with embodiments of the present invention, the method receives a read command from the host which has been recognized as an authorized user for analysis access. In accordance with embodiments of the present invention, the method reads data at an address designated by the read command from a data-storage medium. In accordance with embodiments of the present invention, the method generates data which is different from the data at the designated address and indicates error correction positions in data read from the data-storage medium. In accordance with embodiments of the present invention, the method transfers the data to the host. Thus, in accordance with embodiments of the present invention, the method provides for failure analysis of a data-storage device with a security function without the contents of user data being revealed.

In another embodiment of the present invention, the method receives the data indicating error correction positions from the data-storage device, and displays failure positions in a different form from other areas on a screen of the host based on the received data. Thus, in accordance with embodiments of the present invention, the method provides for an analysis with a user interface.

Embodiments of the present invention provide for failure analysis of a data-storage device with a security function without the contents of user data being revealed. As subsequently described herein, embodiments of the present invention are described in the environment of a hard-disk drive (HDD), as an example of a data-storage device. In accordance with embodiments of the present invention, a HDD has a security function to protect user data from unauthorized accesses. In accordance with embodiments of the present invention, the security function, for example, denies usage of the HDD by an unauthorized user, which provides an authentication function, encrypts user data to store user data to a magnetic-recording disk and returns encrypted user data to an unauthorized user, which provides a user data encryption function. Embodiments of the present invention provide for failure analysis of a HDD with a security function. In accordance with embodiments of the present invention, the method may be applied to HDDs with any of the above-described security functions. In one embodiment of the present invention, the HDD, in a failure analysis by a vendor, transfers data indicating error correction positions in response to a read command from a host without transferring user data stored in a disk. Thus, embodiments of the present invention provide for precise failure analysis of the HDD while hiding the contents of user data, which maintains security.

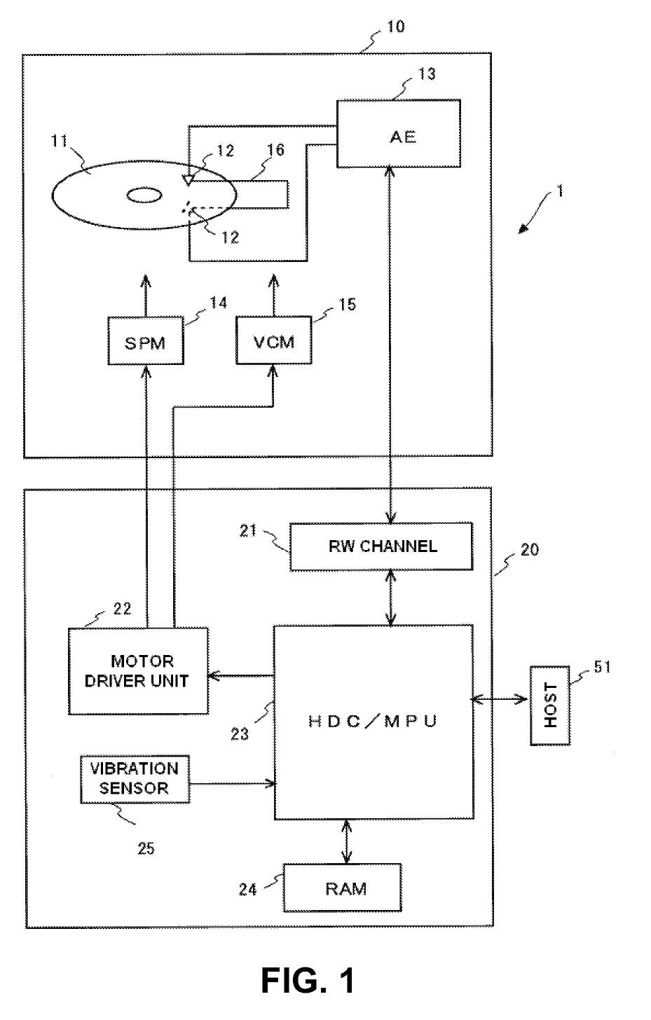

With reference now to FIG. 1, in accordance with an embodiment of the present invention, a block diagram is shown that schematically depicts the configuration of an HDD. HDD 1 has a circuit board 20 fixed outside the disk enclosure (DE) 10. On the circuit board 20, circuit elements are mounted such as a RW channel 21, a motor driver unit 22, an integrated circuit, which is a hard-disk controller/microprocessor unit (HDC/MPU) 23, and a random access memory (RAM) 24.

In DE 10, a spindle motor (SPM) 14 spins a magnetic-recording disk 11 at a specific angular rate. The magnetic-recording disk 11 is a disk for storing data. The motor driver unit 22 drives SPM 14 in accordance with control data from HDC/MPU 23. Each head-slider 12 includes a slider for flying over the magnetic-recording disk and a magnetic-recording head, which is formed on the slider and converts magnetic signals to electric signals and electrical signals to magnetic signals, in other words, reads data and writes data, respectively. The head-sliders 12 are fixed to a tip of an actuator 16. The actuator 16, which is coupled to a voice coil motor (VCM) 15, rotates on a pivot shaft to move the head-slider 12 over the magnetic-recording disk 11 in a nominally radial direction of the magnetic-recording disk 11.

The motor driver unit 22 drives the VCM 15 in accordance with control data from HDC/MPU 23. An arm electronics (AE) module 13 selects a head-slider 12 to access the magnetic-recording disk 11, for reading data from, or writing data to, the magnetic-recording disk 11, from multiple head-sliders 12 and amplifies read-back signals and write signals.

The RW channel 21, in a read operation, amplifies read-back signals supplied from the AE module 13 to have a specific amplitude, extracts data from the obtained read-back signals, and decodes the data. The decoded data is supplied to HDC/MPU 23. The RW channel 21, in a write operation, code-modulates write data supplied from HDC/MPU 23, converts the code-modulated data into write signals, and then supplies the write signals to the AE module 13.

In HDC/MPU 23, a controller, the MPU operates in accordance with firmware loaded to the RAM 24, or a static RAM (SRAM), in the HDC. HDC/MPU 23 performs control of HDD 1 in addition to other processes concerning data processing, such as: reading and writing operation control; command execution order management; positioning control of the head-sliders 12 using servo signals, which is referred to as servo control; interface control to and from a host 51; defect management; and error handling when any error occurs.

HDC/MPU 23 has a security function for user data. As subsequently described herein, in accordance with embodiments of the present invention, a HDD with a user authentication function, for example, a host 51 authentication function, and an encryption function of user data is described that provides a security function. The encryption function encrypts user data with an encryption key and stores the encrypted user data. In a read operation, HDC/MPU 23 decrypts data read from the magnetic-recording disk 11 and transfers the decrypted data.

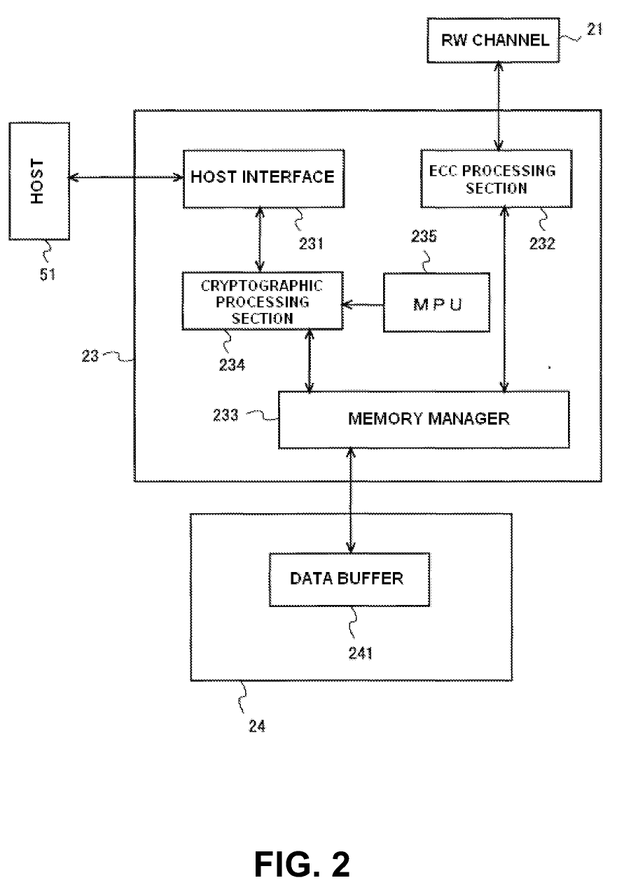

With reference now to FIG. 2, in accordance with an embodiment of the present invention, a block diagram is shown that schematically illustrates a configuration of elements associated with the cryptographic process. HDC/MPU 23 includes a host interface 231, an ECC processing section 232, a memory manager 233, and a cryptographic processing section 234. These are hardware and HDC/MPU 23 includes an MPU 235 operating in accordance with firmware.

The host interface 231 is an interface in data communication with the external host 51. The ECC processing section 232 performs error detection and error correction in data of the magnetic-recording disk. The memory manager 233 performs data flow control, access control for a memory bus and the similar functions. The cryptographic processing section 234 performs encryption and decryption of user data of the magnetic-recording disk 11. A data buffer 241 in the RAM 24 stores temporarily write data and read data.

In a write operation of user data, the write data from the host 51 is transferred to the cryptographic processing section 234 through the host interface 231. The cryptographic processing section 234 encrypts the user data, and transfers the encrypted user data to the memory manager 233. The memory manager 233 stores the encrypted user data to the data buffer 241. The memory manager 233, subsequently, obtains the write data from the data buffer 241 and sends the write data to the ECC processing section 232. The ECC processing section 232 performs processing tasks for error correction on the write data, and sends the write data to the RW channel 21.

In a read operation of user data, the ECC processing section 232 performs the error correction processing on read data from the magnetic-recording disk 11 transferred from the RW channel 21. Subsequently, the read data is stored to the data buffer 241 through the memory manager 233. The memory manager 233 obtains the read data from the data buffer 241 and transfers the read data to the cryptographic processing section 234. The cryptographic processing section 234 decrypts the read data. The decrypted read data is transferred to the host 51 through the host interface 231.

In accordance with embodiments of the present invention, as depicted in FIG. 2, the cryptographic processing section 234 which encrypts and decrypts data is located between the host interface 231 and the memory manager 233. HDD 1 may handle encrypted user data in parts without the host interface 231. Namely, user data in the data buffer 241 are protected by encryption when HDD 1 is working. In the present invention, the cryptographic processing section 234 may be located at another position of the block diagram, for example in the RW channel 21, or alternatively, between the RW channel 21 and the data buffer 241.

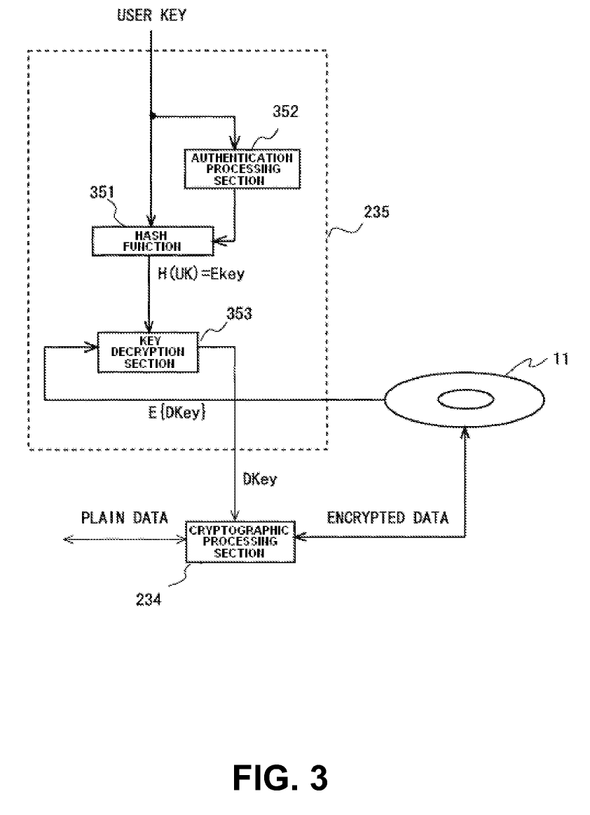

With reference now to FIG. 3, in accordance with an embodiment of the present invention, the authentication process and the encryption/decryption process of user data in reading and writing operations of user data are next described more specifically. The cryptographic processing section 234 utilizes symmetric-key cryptography, which is secret key cryptography, for example, the advanced encryption standard (AES). In accordance with other embodiments of the present invention, other forms of cryptography may also be utilized. An encrypted data encryption key Dkey for user data is stored on the magnetic-recording disk 11. The data encryption key Dkey is encrypted with an encryption key of the hash function of a user key H(UK). As an example, the data encryption key Dkey is encrypted by symmetric-key cryptography.

MPU 235 acts as an authentication processing section 352, and performs the authentication process if MPU 235 receives a user key from the host 51. If the user key shows that the user is an authorized user, which is a condition that obtains without unauthorized access, MPU 235 generates an encryption key Ekey for the data encryption key Dkey from the user key by the hash function 351. MPU 235 acts as a key decryption section 353 and decrypts the encrypted data encryption key E{Dkey} stored in the magnetic-recording disk 11 by use of the encryption key Ekey for the data encryption key Dkey.

In a read operation, the cryptographic processing section 234 decrypts data read from the magnetic-recording disk 11 using the decrypted data encryption key Dkey, and sends the user data in plain text to the host 51. In a write operation, the cryptographic processing section 234 encrypts user data in plain text obtained from the host 51, and transfers the encrypted user data to the magnetic-recording disk 11.

A failure analysis method for HDD 1 with the security function, specifically, is next described. During failure analysis, location of error correction positions, which are error positions, in a data sector is performed. HDD 1 according to the present embodiment reports error corrections positions to the host 51 of a vendor without revealing the contents of user data.

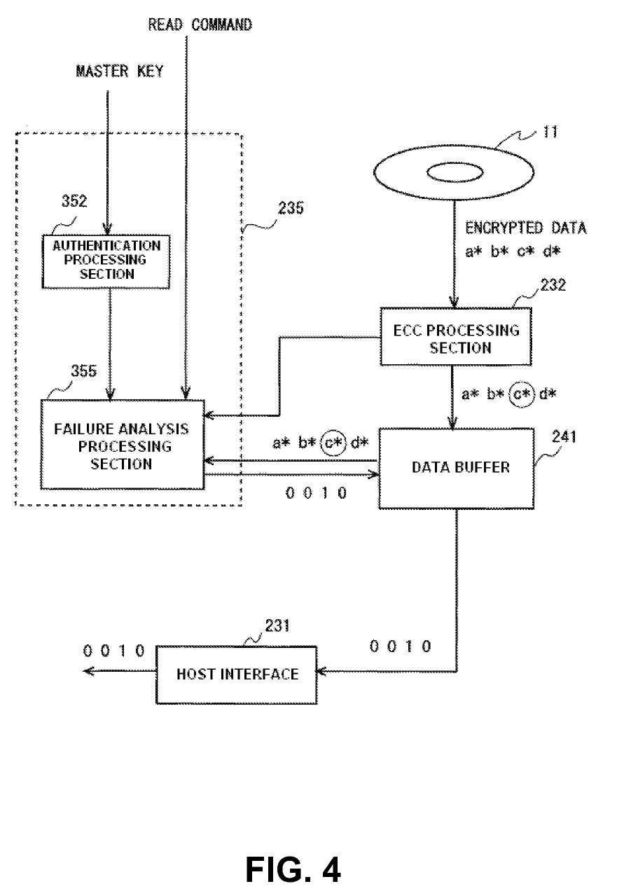

With reference now to FIG. 4, in accordance with an embodiment of the present invention, a block diagram is shown that schematically illustrates a process in which the host 51 reads data from HDD 1 in the failure analysis of HDD 1. The host 51 of a vendor has a master key, and sends the master key to HDD 1. MPU 235 acting as the authentication processing section 352 performs the authentication process of the master key obtained from the host 51. If the master key is an authorized key, MPU 235 acts as a failure analysis processing section 355 to start a read operation for the failure analysis.

The failure analysis processing section 355 reads data at an address designated by a read command from the host 51 from the magnetic-recording disk 11. Specifically, the failure analysis processing section 355 indicates a disk manager (not shown) in the HDC to read data at the designated address. The data read from the magnetic-recording disk 11 is transferred to the ECC processing section 232 through the RW channel 21. The transferred data is encrypted and in FIG. 4, an example of read data is illustrated as a*b*c*d*. Each of a, b, c, d is 4-bit data in hexadecimal and encrypted data is followed by *. Each of a, b, c, d is 4-bit data in hexadecimal and encrypted data also is followed by * in descriptions of subsequent drawings.

The ECC processing section 232 performs the error correction of the data a*b*c*d*, and transfers the error corrected data to the data buffer 241. In the example of FIG. 4, the data c* is error corrected and circled. An example to indicate error correction positions 4-bit data-by-4-bit data is subsequently described. For the unit in indicating an error correction position, a proper value, for example 1-bit data or 1-byte data, is selected depending on HDD design.

If data read from the magnetic-recording disk 11 is stored to the data buffer 241, the failure analysis processing section 355 obtains the error correction result from the ECC processing section 232. The error correction result indicates error correction positions. The failure analysis processing section 355 creates data indicating the error correction positions according to the error correction result. In one embodiment of the present invention, the created data has the same length as the data a*b*c*d* read from the magnetic-recording disk 11 and a value to indicate an error correction position is a specified value.

In accordance with embodiments of the present invention, as depicted in FIG. 4, non-corrected data (4-bit data in the example of FIG. 4) are indicated by 0 (0000) and corrected data is indicated by 1 (1111). The data (1111) for indicating an error correction position is inverted data of the data (0000) for indicating a non-correction position. The failure analysis processing section 355 generates data 0010 according to the error correction result, and transfers data 0010 to the host 51 through the host interface 231.

The host 51 refers to the data 0010 transferred from HDD 1 to find error correction positions in the address designated by the read command, and checks the error correction capability of HDD 1. Repeating the process allows the host 51 to form a map indicating error correction positions on a recording surface of the magnetic-recording disk 11. The host 51 displays failure positions in a different form from other areas on a screen. The display of failure positions in a different form from other areas on a screen allows a researcher to check the error position map according to the information the host 51 has obtained from the HDD, and to analyze failures of HDD 1, precisely. The data the host 51 obtains is different from the user data abcd; and, thus, the contents of the user data to be protected are not revealed.

For indicating error correction positions, in accordance with embodiments of the present invention, data transferred to the host 51 has the same data length as the data length designated by the read command and data at a correction position may be specified data. In the above example, non-corrected data is indicated by a specific fixed pattern, which is a string of bits of “0” in the above-described example; and, error corrected data is indicated by the inversed data, which is a string of bits of “1” in the above-described example, which allows providing the host 51 with data for the failure analysis by a simple rule and process while hiding the contents of user data.

As described above, if error correction is completed successfully with an ECC code, data indicating error positions is transferred. However, if there are more errors than the error correction capability of the ECC code, the failure analysis processing section 355 sends data indicating that error correction is barred. In one embodiment of the present invention, the failure analysis processing section 355 sends data 0000 obtained by inversing all bits of a fixed pattern 0000. If a data sector, where error correction is barred, is found in a usual read operation, MPU 234 reports the data sector to the host 51. As described above, specified data with the same data length as the data length designated by the read command provides a similar process to a process in which the error correction of data is not barred.

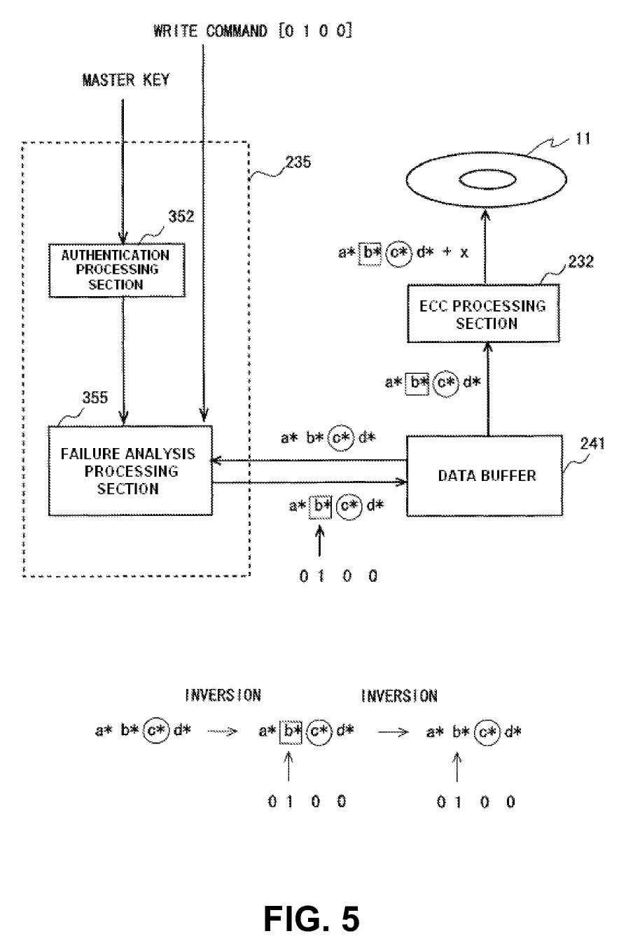

With reference now to FIG. 5, in accordance with an embodiment of the present invention, a data write method in the failure analysis is next described referring to a block diagram depicted in FIG. 5. In failure analysis, writing data at designated addresses and reading data at designated addresses allows a more precise analysis. However, user data is stored in a magnetic-recording disk; and, the loss of data not acceptable. HDD 1 of the present embodiment allows data writing in a failure analysis without revealing the contents of user data, and without losing the data.

A process is next described that writes data to the same address, after the read operation described referring to FIG. 4. If the authentication processing section 352 has successfully completed the authentication process of the master key, the failure analysis processing section 355 obtains a write command and data indicating positions to inverse data from the host 51. The write command designates an address to write data; and, in this example, the address designated by the write command to write data is the same as the address in the read operation in FIG. 4. The procedure for utilizing the write command to designate an address to write data that is the same as the address in the read operation allows a test to embed bit errors at any positions.

The failure analysis processing section 355 obtains the data a*b*c*d* of the address stored in the data buffer 241. ‘c*’ is an error corrected data and circled in FIG. 5. The failure analysis processing section 355 has obtained the data indicating data inversion positions 0100. The data indicating data inversion positions 0100 indicates that the second 4-bit data should be inversed. Specifically, the data 0100 is 16-bit data represented by four 4-bit data strings such that the fifth bit to the eighth bit are 1's, and the other bits are 0's.

The failure analysis processing section 355, as the write command from the host indicates, creates data by inversing b* in the data a*b*c*d* and stores the data created by inversing b* in the data a*b*c*d* to the data buffer 241. The failure analysis processing section 355 orders the memory manager 233 to write the data a*b*c*d* including the bit-inversed b* to the designated address on the magnetic-recording disk 11. The ECC processing section 232 creates, and adds the ECC data x of the data a*b*c*d* following the usual procedure. The failure analysis processing section 355, subsequently, reads the data again, and provides the information for the failure analysis to the host 51 in accordance with an order from the host 51.

If the associated processes are completed, the host 51 provides again HDD 1 with an instruction to write data to the address. The address indicated by the write command and the data indicating the inversion position are the same as the first data writing, which allows the original encrypted user data to be written to the address where the data has been changed.

As shown in the lower part in FIG. 5, all bits of the data b* are inversed in the first write operation. In the second write operation, all bits of the data b* are inversed again. Thus, the data b* returns to the original string of bits. The bit inversion allows the host 51 and HDD 1 to write data for the failure analysis without losing data on the magnetic-recording disk 11 by repeating an operation, for example, the write operation. In the above example, all the bits of the indicated data b* are inversed. In the alternative, in accordance with another embodiment of the present invention, a part of the bits may be inversed. An exclusive OR operation with specific data allows inversing any bits.

The above example performs a read operation, and then a write operation at the same address. In the alternative, in accordance with another embodiment of the present invention, a write operation may be performed without a read operation. The process of the host 51 and HDD 1 is the same as the process explained referring to FIG. 5. The host 51 issues a write command with an address and an inversion instruction to HDD 1 two times, which allows writing data in a failure analysis without losing user data on a magnetic-recording disk 11.

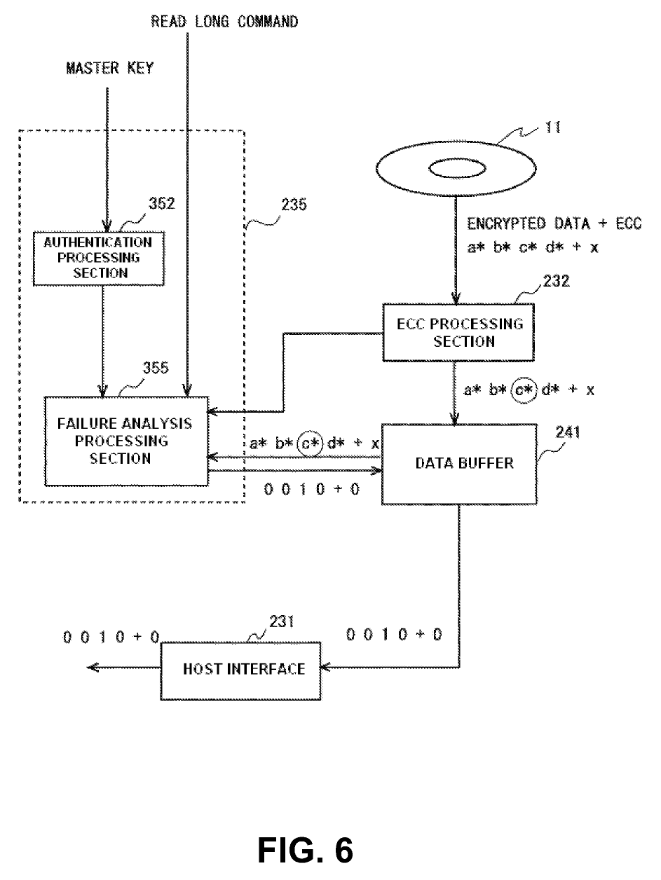

With reference now to FIG. 6, in accordance with an embodiment of the present invention, an operation for a read long command in a failure analysis of HDD 1 is next described referring to a block diagram shown in FIG. 6. A read long command is a special read command, and instructs a HDD to transfer the ECC code of a designated data sector in addition to the user data in the data sector. The operation in response to the command is basically the same as the operation in response to the ordinary read command described with reference to FIG. 4.

The difference between the operation in response to the command and the operation in response to the ordinary read command described with reference to FIG. 4 is that the ECC code x is transferred in addition to the user data a*b*c*d* in response to the read long command. The failure analysis processing section 355 reads the user data a*b*c*d* and the ECC code x according to the read command. Moreover, the failure analysis processing section 355 creates data to be transferred to the host 51 depending on the error correction result obtained from the ECC processing section 232.

The failure analysis processing section 355 creates new data regarding the user data a*b*c*d* in the same way as the ordinary read operation in FIG. 4. From a security point of view, the ECC code x is not to be revealed, either. The failure analysis processing section 355 creates new data corresponding to the ECC code x in accordance with the same rule as that in data creation for user data. In the example in FIG. 6, the data c* is corrected. Accordingly, the data corresponding to the c* is a bit string of 1's (15 in decimal); and, data corresponding to the other data consists of bit strings of 0's.

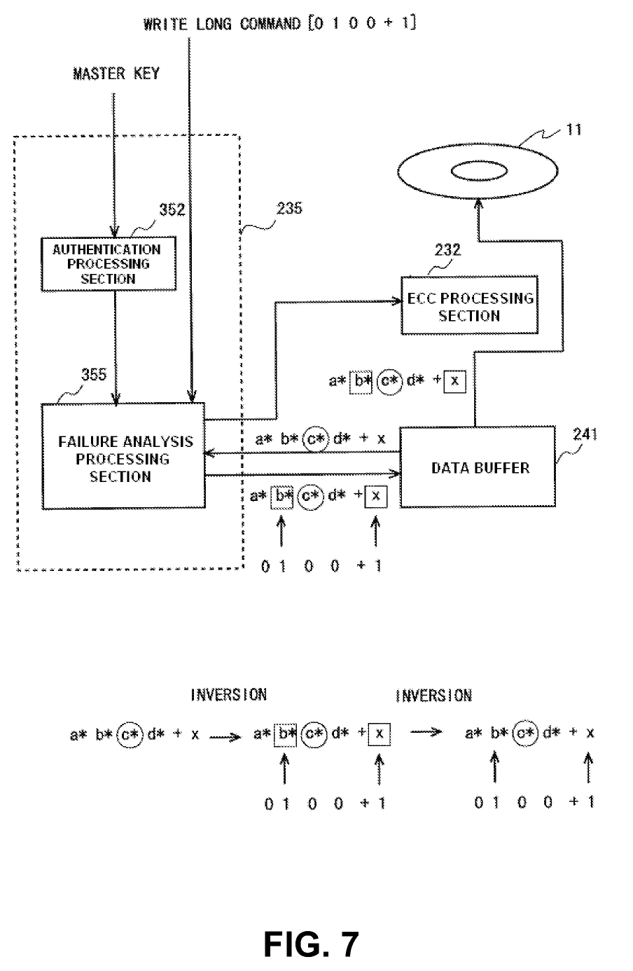

With reference now to FIG. 7, in accordance with an embodiment of the present invention, an operation to a write long command in a failure analysis of HDD 1 is next described referring to a block diagram shown in FIG. 7. A write long command instructs a HDD to write a specified ECC code in addition to user data. The operation in response to the command is basically the same as the operation for the ordinary write command described with reference to FIG. 5.

Typically, a write long command is issued after a read long command. The designated address in the write long command is the same as the read long command. An operation to a write long command issued after the read command explained referring to FIG. 6 is next described.

If an authentication process by the authentication processing section 352 is completed successfully, the failure analysis processing section 355 receives a write long command from the host 51. The write long command is with a specified address and specified inverse positions. In an example in FIG. 7, data instructing the inversion of b* in the user data and the ECC code is transferred. The format of data indicating the inversion positions is the same as the write operation described with reference to FIG. 5.

The failure analysis processing section 355 obtains a set of the user data and the ECC code a*b*c*d*+x in the data buffer 241. The failure analysis processing section 355 refers to the inversion instruction data 0100+1 transferred with the write long command and inverses a part of the data a*b*c*d*+x. Specifically, the failure analysis processing section 355 inverses all bits of the data b* and all bits of the ECC code.

The failure analysis processing section 355 stores the data with inversed specified bits to the data buffer 241, and instructs the memory manager 233 to transfer the data with inversed specified bits to the magnetic-recording disk 11 through RW channel 21. In the operation, the failure analysis processing section 355 turns off the function of the ECC processing section 232. The data in the data buffer is transferred to the RW channel 21 without the process in the ECC processing section 232, which allows writing a data sector with an ECC code instructed by the host 51.

In the write process described in the discussion of FIG. 5, only one write process leaves user data changed on the magnetic-recording disk 11. Thus, the host 51 reissues the same write long command. The lower part of FIG. 7 depicts a data sector on the magnetic-recording disk which is recovered by performing two times write processes with the same write long command. The data inversion method is the same as the normal write process described referring to FIG. 5. All, or a part of, bits in the indicated data may be inversed.

As described above, the failure analysis processing section 355 transfers a fixed pattern in which data indicating error correction positions are different from other parts and which is irrelevant to user data stored in the magnetic-recording disk 11. In contrast to this, an example for transferring data stored on the magnetic-recording disk 11 to the host 51 is next described. Data on the magnetic-recording disk 11 is encrypted. Thus, transferring the data to the host 51 presents no security issues. However, encrypted data is not enough for an accurate failure analysis.

In the present embodiment, the failure analysis processing section 355 reads data from a magnetic-recording disk, and subsequently rewrites data at the address, which provides a more accurate failure analysis with the data before, and after, rewriting. Moreover, the failure analysis processing section 355 rewrites the original data to the rewritten location after rewriting the data in order not to lose the user data. This method is the same as the above-described method of FIG. 5 and FIG. 7. Processes in response to a read long command and a write long command are next described.

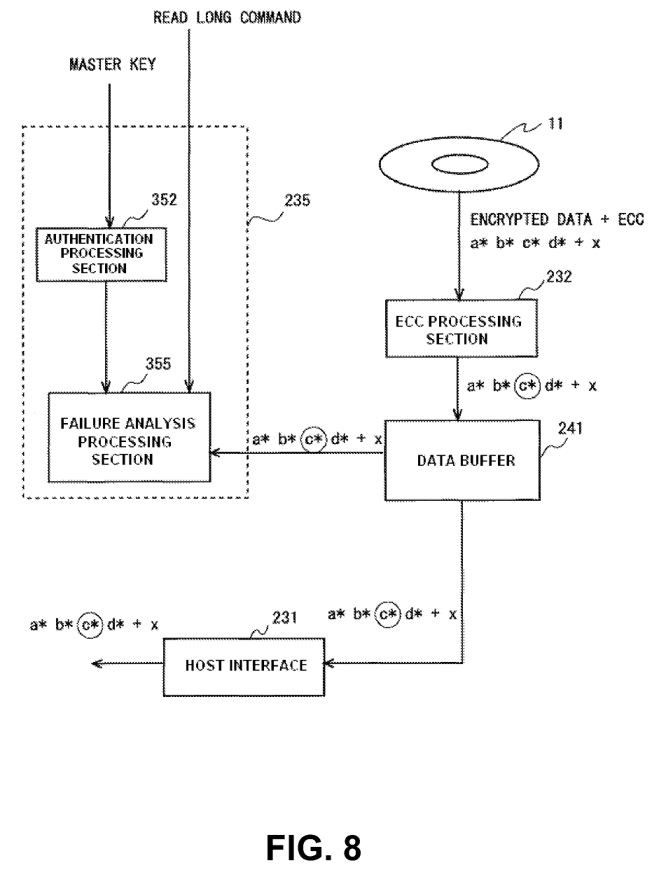

First, with reference now to FIG. 8, in accordance with an embodiment of the present invention, the process for the read long command is described referring to FIG. 8. If the authentication processing section 352 completes the authentication process of the master key successfully, the failure analysis processing section 355 retrieves a user data a*b*c*d* and an ECC code x at the designated address in accordance with a read long command from the host 51. In the example of FIG. 8, the ECC processing section corrects the data c*. The failure analysis processing section 355 transfers the data a*b*c*d*+x read from the magnetic-recording disk 11 without being processed to the host 51 through the host interface 231.

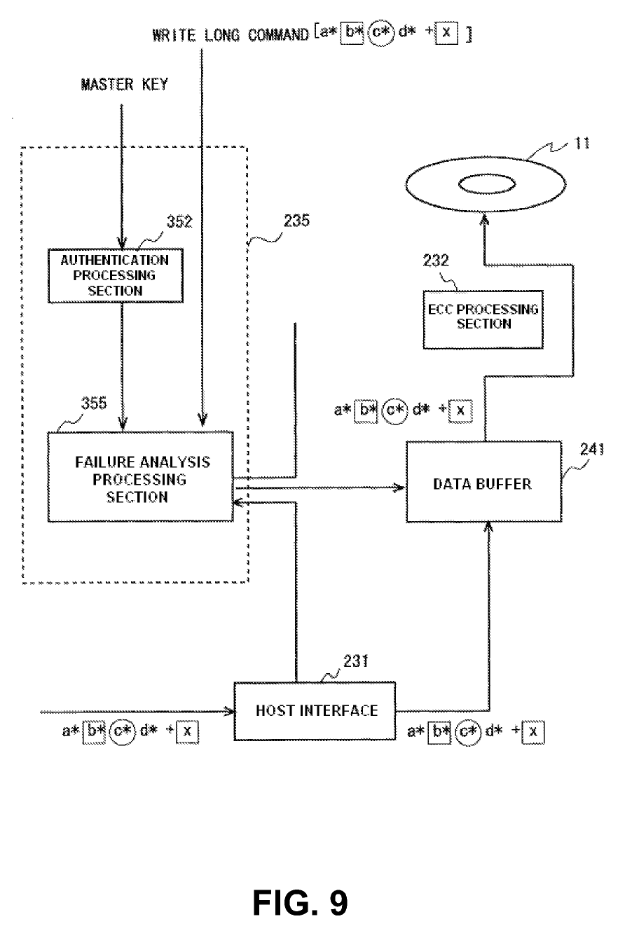

With reference now to FIG. 9, in accordance with an embodiment of the present invention, as depicted in a block diagram of FIG. 9, the host 51 subsequently issues a write long command designating the same address as the one in the read long command. The write long command is accompanied by the designated address and write data to be written. The write data is the data obtained by inversing a part of the bits in a*b*c*d*+x. In the example of FIG. 9, bits of b* and x are inversed.

The write data is stored to the data buffer 241 through the host interface 231. The failure analysis processing section 355 writes data transferred from the host 51 to the magnetic-recording disk 11. The function of the ECC processing section 232 is turned off in the process that writes the data with ECC code transferred from the host 51 to the magnetic-recording disk 11. After the process associated with failure analysis, the host 51 issues a write long command to return the data sector rewritten on the magnetic-recording disk 11 to the state before the rewriting.

As set forth above, the embodiments of the present invention have been described by way of examples; but, embodiments of the present invention are not limited to the above-described examples, as embodiments of the present invention may of course be modified in various ways within the spirit and scope of embodiments of the present invention. For example, embodiments of the present invention may be applied to disk drives which employ disks for storing data that are different from magnetic-recording disks.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A data-storage device with a security function for user data stored in a data-storage medium, comprising:
said data-storage medium for storing data;
an authentication processing section for performing an authentication process with a key obtained from a host;
an error correction circuit for performing error correction in reading data at an address designated by a read command from a host which has been recognized as an authorized user for analysis access by said authentication processing section; and
an analysis processing section for generating data indicating said positions of said error correction and transferring said data to said host.

2. The data-storage device of claim 1, wherein generated data has a same data length as data designated by said read command, and said generated data is data in which bits at error corrected positions are different from other bits in a specified fixed data pattern.

3. The data-storage device of claim 1, wherein if error correction of data designated by said read command is barred, said analysis processing section is configured to transfer data whose data length is same as said designated data and having a specified bit pattern to said host.

4. The data-storage device of claim 1, wherein said analysis processing section is configured to receive a write command designating an address in said data-storage medium and bit inversion positions, and is configured to write data obtained by inverting bits at designated positions in data read from said address to said address.

5. The data-storage device of claim 1, wherein said read command is a read long command for instructing transfer of data at a designated address and an ECC code.

6. The data-storage device of claim 5, wherein said analysis processing section is configured to receive a write long command designating a same address as said read long command and designating bit inversion positions in said data at said designated address and an ECC code, and is configured to write data obtained by inverting bits at said designated positions in said data read from said designated address and said ECC code to said address.

7. An analysis method of a data-storage device with a security function for user data, comprising:
performing an authentication process of access from an authorized host for analysis with a key obtained from said host;
receiving a read command from said host which has been recognized as an authorized user for analysis access;
reading data at an address designated by said read command from a data-storage medium;
generating data which is different from said data at said designated address and indicating error correction positions in data read from said data-storage medium; and
transferring said data to said host.

8. The analysis method of claim 7 further comprising:
receiving said data indicating error correction positions from said data-storage device; and
displaying failure positions in a different form from other areas on a screen of said host based on said received data.

9. The analysis method of claim 7, wherein said generated data has a same data length as said data designated by said read command, and said generated data is data in which bits at error corrected positions are different from other bits in a specified fixed data pattern.

10. The analysis method of claim 7, wherein, if error correction of data designated by said read command is barred, data whose data length is same as said designated data and having a specified bit pattern are transferred to said host.

11. The analysis method of claim 7, further comprising:
receiving a write command designating an address in said data-storage medium and bit inversion positions, and
writing data obtained by inverting bits at designated positions in data read from said address to said address.

12. The analysis method of claim 7, wherein said read command is a read long command for instructing transfer of data at a designated address and an ECC code.

13. The analysis method of claim 12, further comprising:
receiving a write long command designating a same address as said address of said read long command and designating bit inversion positions in said data at said designated address and an ECC code, and
writing data obtained by inverting bits at designated positions in said data read from said designated address and said ECC code to said address.
